(19) United States
(12) Patent Application Publication
(10) Pub. No.: US 2011/0042848 A1
(43) Pub. Date: Feb. 24, 2011

(54) METHOD OF MAKING A MOLDED TRIM ASSEMBLY

(76) Inventors: CHARLES E. ASH, Perrysburg, OH (US); Susan M. Herczeg, Perrysburg, OH (US); Charles Sitterlet, Northwood, OH (US)

Correspondence Address: MARSHALL & MELHORN, LLC, FOUR SEAGATE - EIGHTH FLOOR, TOLEDO, OH, 43604, US

(21) Appl. No.: 12/850,698

(22) Filed: Aug. 5, 2010

Related U.S. Application Data
(60) Provisional application No. 61/236,250, filed on Aug. 24, 2009.

(51) Int. Cl. B29C 45/14

(52) U.S. Cl. 264/265

(57) ABSTRACT

The present invention relates to a method of making a molded trim assembly for a vehicle, which trim assembly has a molded polymeric frame with a bright trim piece integrally molded therein, which integral assembly is molded onto a vehicle window and can thereafter be installed in an opening in the vehicle body.

### RELATED APPLICATION

This application is claiming the benefit, under 35 U.S.C. 119(e), of the provisional application filed Aug. 24, 2009 under 35 U.S.C. 111(b), which was granted Ser. No. 61/236,250. This provisional application is hereby incorporated by reference in its entirety.

### FIELD OF THE INVENTION

The present invention relates to a method of making a molded trim assembly for a vehicle window.

### BACKGROUND OF THE INVENTION

In the past, multi-component trim assemblies were common for vehicle windows. They were expensive to make and expensive and difficult for the vehicle manufacturer to install. Often, various fasteners were needed to assemble the various components and other fasteners were needed to install the trim assemblies in the opening of a vehicle body. A metal or metallic-appearing trim piece (also known as bright trim) was sometimes a prominent visible component of such multi-component assemblies.

As automotive styles changed, and reducing the cost of vehicle production became an area of greater emphasis, molded polymeric window trim replaced the multi-component trim assemblies, and in large part eliminated the metal trim component. In situ molding of trim parts by various methods, including injection molding and reaction injection molding (RIM) became, and remains, quite popular. Such molded assemblies have many advantages; including few component parts (even one-piece, or integral, assemblies), ease of installation in the vehicle body, often being adhesively bonded to the vehicle sheet metal, thus requiring no other fasteners, lower cost, and good sealing against wind and weather.

Recently, however, automotive stylists have indicated an interest in again having bright trim accents around certain vehicle windows, without sacrificing the benefits of molded polymeric trim. Therefore, it would be desirable to be able to produce a polymeric molding having a bright trim component that is part of an assembly molded onto the periphery of a vehicle window and which assembly can be adhesively bonded to the sheet metal in the opening of a vehicle body.

Vehicle window trim assemblies have been reported in the patent literature, for example:

U.S. Pat. No. 3,811,989 to R. Hearn describes a decorative trim strip having a surface displaying a metalized finish and which comprises a substrate of an extruded heat-resistant plastic material, to the front face of which is bonded a metal or metalized strip to provide the metalized finish. A protective plastic layer may cover the metal or metalized strip.

U.S. Pat. No. 4,904,014 to S. Aarovitz et al., describes a decorative trim molding assembly for a stationary quarter window of an automotive vehicle. The mold assembly includes a plastic panel or bezel surrounding the window and a generally C-shaped reveal molding attached thereto by force- or snap-fitting.

U.S. Pat. No. 4,483,113 to W. Kruschwitz describes an arrangement for mounting a window glass in a frame of a window opening including a flexible support means for supporting the arrangement on the frame of the window opening and defining a surface of such flexible material encircling the window opening for receiving the window glass, the surface of the flexible material also defining a slit into which slit is inserted a wall of a stiff, longitudinally extending frame, and an oppositely projecting wall of the frame engaging the outside surface of the window glass around its periphery. The assembly also includes a removable stiffening member which is inserted into a longitudinal slot in the flexible material so as to aid in holding the frame in position.

U.S. Pat. No. 4,072,340 to C. Morgan describes a vehicular window assembly formed as a complete unit prior to installation and requiring only final securement of attaching means from the interior of the vehicle to complete installation of the assembly. The assembly includes a molded plastic casing or gasket, molded onto a transparent window and an attachment member for attaching the casing to the body.

U.S. Pat. No. 4,858,988 to C. Morgan describes a vehicular window assembly having a sheet-like window panel with a peripheral edge, a casing molded from a resinous plastic material around a first portion of the peripheral edge of the window panel, and trim means for covering and finishing at least portions of the periphery of the assembly including a second portion of the peripheral edge of the window panel. When assembled with a vehicle body, the casing and trim fill spaces between the window panel and body.

U.S. Pat. No. 5,358,764 to E. Roberts et al., describes a decorative trim assembly including an integrally molded T-shaped decorative trim made of a hard plastic leg portion with a top portion, soft plastic tip portions bound to the top of the leg, a decorative metallic portion molded to the top of the leg portion and a locking flange member at the edge of the leg portion.

U.S. Pat. No. 4,322,105 to K. Onda describes a decorative arrangement for an automotive vehicle body structure having a window glass attached thereto, the decorative arrangement including a flexible weather strip holding the window glass to the vehicle body structure and a molding attached to the vehicle body structure, extending along the outer perimeter of the weather strip, wherein the molding has a marginal portion secured to the vehicle body structure along and in close proximity to the outer perimeter of the weather strip. Further, the weather strip has a lug portion extending along the weather strip arranged to conceal the marginal portion of the weather strip between the lug portion and the vehicle body structure.

U.S. Pat. No. 5,028,460 to K. Kimura et al., describes an elongate molding member including a core element and a cover element made of a synthetic resin material, and co-extruded about the core element. The core element has a strip-like ornamental portion which is different in color from the synthetic resin material of the cover element and is to be exposed to the outside by removing a separate portion defined by at least one longitudinal slit in the cover element.

U.S. Pat. No. 6,238,769 to H. Nishio et al., describes a window molding for a vehicle including a leg portion arranged between an outer peripheral surface of a windshield and a body panel and having an opposite surface faced to the outer peripheral surface of the windshield, a head portion integrally formed on the leg portion and having a contacting surface in contact with an outer surface of an edge of the windshield, an engaging portion integrally formed on the leg portion and in contact with an inner surface of the edge of the windshield, a lip portion integrally formed on the leg portion or the head portion and in contact with the body panel, and a core member buried into part of the head portion located outside the outer peripheral surface of the windshield, and extending in the longitudinal direction of the head portion.

U.S. Pat. No. 4,332,412 to T. Nakazawa et al., describes an accessory molding strip for motor vehicle bodies including an at least partially exposed wrapping member made of stainless steel, and a reinforcing member made of plastic and bonded to the rear surface of the wrapping member throughout the length of the wrapping member.

### SUMMARY OF THE INVENTION

The present invention relates to a method of making a molded trim assembly for a vehicle window. More specifically, the molded trim assembly includes as an integral component thereof a bright trim piece; that is, a preferably metal trim piece having a base member and an exposed brushed or polished show surface that will be visible from the exterior of the vehicle, around at least a portion of the periphery of the vehicle window.

As previously noted herein, past bright trim window assemblies have been made up of many components, including internal fasteners, and fasteners to attach the assembly to a vehicle body. The trim assembly of the present invention preferably requires no such mechanical fasteners, either internally or for installation in the vehicle body opening. In a preferred embodiment, the trim assembly of the present invention comprises an integral trim assembly comprising a vehicle window having a polymeric frame or gasket molded thereon, and a bright trim component molded therein with the show surface of the bright trim piece being exposed.

The method of making the molded trim assembly according to the present invention utilizes a molding apparatus having separable upper and lower mold portions. At least the lower mold portion comprises a mold cavity having a shape substantially corresponding to the shape of the vehicle window onto which the trim assembly is to be molded. A vehicle window and a trim piece are placed into the lower mold portion so that at least a portion of its peripheral edge extends into the mold cavity. The vehicle window and/or the trim piece are heated to a temperature greater than 120° F., preferably greater than 180° F., and most preferably 200° F. or greater. Pre-heating of the vehicle window may occur in a location remote from the molding apparatus, or in the molding apparatus. Similarly, the trim piece may be pre-heated either in a location remote from the molding apparatus or after placement in the molding apparatus. The trim piece having a base portion and a bright show surface is placed into the mold cavity in a location, at least in part, adjacent the peripheral edge of the vehicle window. The mold is then closed and a liquid polymeric material is injected into and fills the mold cavity. After curing the polymeric material for a sufficient time, the mold is opened to reveal a vehicle window having a polymeric frame or gasket with the trim piece molded therein. This integral assembly may then be conveniently installed in the opening in a vehicle body.

From the foregoing disclosure and the following more detailed description of various preferred embodiments, it will be apparent to those skilled in the art that the present invention provides a significant advance in the technology of molded trim assemblies. Additional features and advantages of various preferred embodiments will be better understood in view of the detailed description provided herein.

### BRIEF DESCRIPTION OF THE DRAWINGS

FIG. 1 is a plan view of the integral window assembly in accordance with the invention.

FIG. 2 is a cross-sectional view along the line 2-2 of FIG. 1 showing the window assembly in accordance with the invention.

FIG. 3 is a cross-sectional view of a molding apparatus for use in the method of the present invention in a closed position.

FIG. 4 is a plan view of the lower mold portion of the molding apparatus of FIG. 3.

FIGS. 5a and 5b are cross-sectional views of two alternate embodiments the bright trim component of the window assembly in accordance with the invention.

It should be understood that the appended drawings are not necessarily to scale, presenting a somewhat simplified representation of various preferred features illustrative of the basic principles of the invention. The specific features of the molded trim assembly as disclosed herein will be determined in part by the particular intended application and use environment.

### DETAILED DESCRIPTION OF THE PREFERRED EMBODIMENT

The invention relates to a method of making a molded trim assembly for a vehicle window which includes, as an integral component thereof, a bright trim piece. The molded trim assembly comprises a molded polymeric frame which incorporates the bright trim piece and is also molded onto the peripheral edge of a vehicle window. The molded trim assembly of the present invention may then be readily installed in the opening in a vehicle body.

It is a feature of the present invention that no separate mechanical fasteners are necessary. Thus, such fasteners are not used to form the molded trim assembly, nor is it necessary to utilize separate mechanical fasteners to install the molded trim assembly into the opening of the vehicle body.

It is an additional feature of the present invention that the bright trim piece is integrated into the molded trim assembly during the molding operation such that no post-molding operations are needed to expose the brushed or polished show surface of the bright trim piece, so as to make such show surface visible from the exterior of the vehicle into which the trim assembly is installed.

The molded trim assembly of the present invention is made, in part, by one of the well known injection molding or reaction injection molding (RIM) processes, utilizing a molding apparatus comprising upper and lower mold portions. The mold portions are preferably made of aluminum or steel, but may be made from any suitable material.

A mold cavity substantially conforming to the shape of a vehicle window is machined in at least the lower of the upper and lower mold portions. Preferably, complementary mold cavity portions of the lower mold cavity are formed in the upper mold portion to support the glass sheet. At least one resilient support is provided in the lower mold portion.

It is a discovery of the present invention that pre-heating the vehicle window and the bright trim piece onto which the trim assembly comprising the polymeric frame and bright trim piece is to be molded greatly enhances the success of forming the molded-on trim assembly. It has further been discovered that by such pre-heating, at least the vehicle window must reach a temperature of greater than 120° F., preferably greater than 180° F., most preferably, greater than 200° F. In a preferred process, both the vehicle window and the bright trim piece are preheated in the above-described temperature range.

Preferably, such pre-heating is performed at a location remote from the molding apparatus; however, it is within the scope of the invention to perform such pre-heating in the mold apparatus.

While pre-heating of the bright trim piece and/or the glass sheet of the molded trim assembly can be accomplished in any suitable way for example, by infrared heating or conduction heating, a preferred means of such pre-heating is by induction heating. Induction heating can be accomplished by one or more coils being proximate the bright trim piece and/or the glass sheet. Such induction coils can be stationary or movable, and preferably operate in a frequency range of 5-50 khz.

Also, prior to placing the vehicle window into the molding apparatus, an adhesion-promoting primer is preferably applied to the peripheral portion of the vehicle window onto which the trim assembly is to be molded.

A pre-heated (or to be pre-heated) vehicle window is placed into the lower mold portion so that at least a portion of its peripheral edge extends into the mold cavity formed in the lower mold portion.

A trim pre-heated (or to be pre-heated) piece having a base portion and a bright show surface is placed into the mold cavity in a location, at least in part, adjacent the peripheral edge of the vehicle window.

The upper and lower mold portions are then brought into intimate molding contact. Thereafter, a liquid polymeric material is injected into the molding apparatus in a quantity sufficient to fill the mold cavity. After allowing sufficient time for the polymeric material to at least partially cure, the upper and lower mold portions are disengaged and a vehicle window having the trim assembly with integral bright trim piece molded therein is removed from the molding apparatus. As such, it is ready for installation in a vehicle body opening with no need for any post-molding operations.

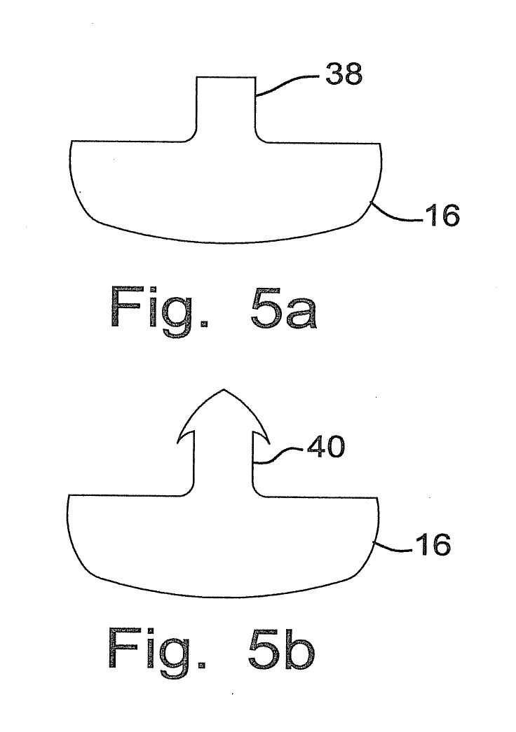

Liquid polymeric materials useful in connection with the present invention include both thermoset and thermoplastic materials. Examples of suitable materials include polyvinyl chloride (PVC) as well as two component polyurethane systems comprising an isocyanate and a polyol component. The bright trim piece is preferably comprised of a metal or metallic-appearing material. Such trim piece may have a base portion which may be in various configurations as shown in cross-sectional profile in FIGS. 5a, 5b, while utilizing the adhesive qualities of the present invention to form a primarily chemical interlock between the trim piece and the polymeric material. Such trim piece will also have a preferably brushed or polished show surface attached to the base portion. Certain configurations of the base portion of the bright trim piece may provide a beneficial mechanical interlock with the cured polymeric material to ensure that the bright trim piece remains an integral part of the molded trim assembly. Incorporation of more than one bright trim piece in a single trim assembly is within the scope of the invention.

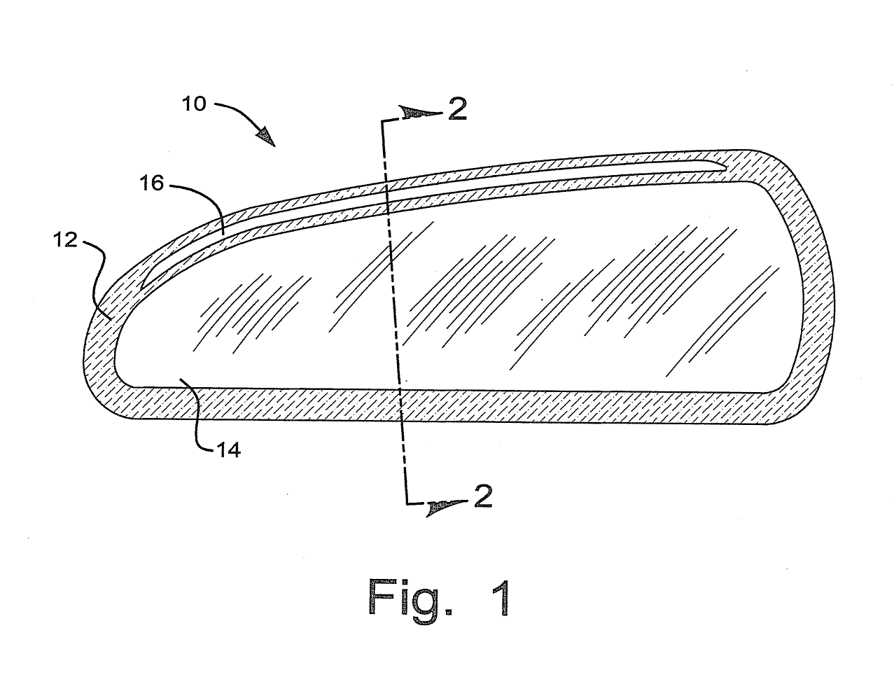

FIG. 1 shows an example of a molded trim assembly 10 made by the method of the present invention. The polymeric frame 12 is molded onto vehicle window 14. The frame 12 can be molded onto one or more of a first major surface of the vehicle window 14, a first major surface and a peripheral edge portion of the vehicle window 14 and both major surfaces and a peripheral edge portion of the vehicle window 14. Such encapsulation profiles are also sometimes referred to as one-, two- and three-sided encapsulation respectively. The brushed or polished show surface 17 of the bright trim piece 16 is readily visible, molded into the polymeric frame 12.

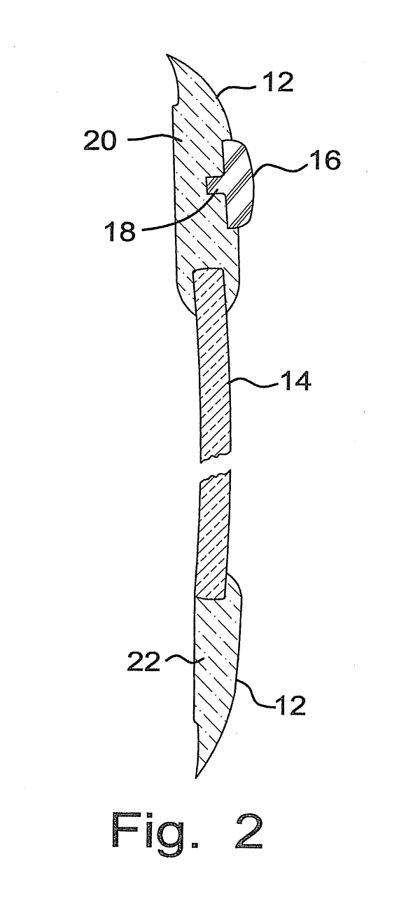

FIG. 2 shows in a cross-sectional view the molding process creates an integral assembly incorporating the vehicle window 14 the bright trim piece 16 and the polymeric frame 12. The base portion 18 of bright trim piece 16 helps to “key” the bright trim piece 16 into the polymeric material of frame 12. Upper portion 20 of frame 12 illustrates a so-called three-sided encapsulation, while lower portion 22 of frame 12 is a two-sided encapsulation. As previously noted, one or more different profiles on a single vehicle window are within the scope of the present invention.

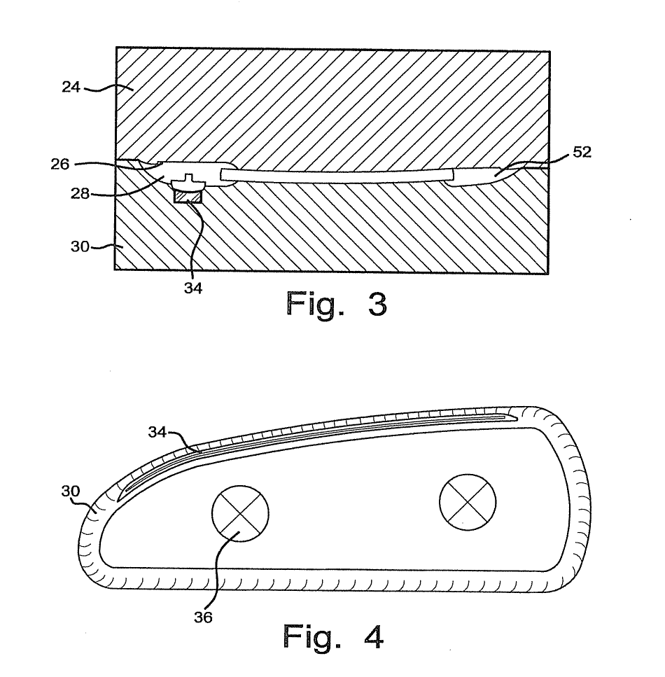

FIG. 3 shows, in cross-section, atypical molding apparatus to implement the molding process of the present invention. The upper mold portion 24 may have a mold cavity, or portions thereof formed therein. For example, in FIG. 3, a cavity portion 26 corresponding to the upper portion of the polymeric frame 12 is formed to allow for cooperation with the mold cavity 28 formed in lower mold portion 30 to provide for a three-sided encapsulation of the vehicle window by the polymeric material forming the frame 12. By contrast, no such mold cavity portion in the upper mold portion 24 is necessary for the two-sided encapsulation of the lower frame portion.

The mold cavity portion 32 formed in the lower mold portion 30 includes molding areas for the polymeric frame but also a molding area 34 for bright trim piece 16. As previously noted, the bright trim piece 16 is placed into molding area 34 prior to the molding operation. Soft seals or other known methods are utilized in the mold to ensure that the molding material does not contact show surface 17 of bright trim piece 16.

It may be necessary to utilize additional measures to maintain the bright trim piece 16 in its proper position in molding area 34. One possible measure is to create a magnetic force in the molding area 34. Another possible measure is the use of suction, i.e. negative pressure.

FIG. 4 shows the lower mold portion of the molding apparatus of the present invention with a mold cavity formed therein, including the molding area 34 for bright trim piece 16. Resilient support 36 for the vehicle window while in the mold is also illustrated.

FIGS. 5a and 5b illustrate exemplary configurations of bright trim piece 16. In FIG. 5a base portion 38 of bright trim piece 16 assists in “keying in” the bright trim piece to the polymeric material of the frame. Base configuration 40 as shown in FIG. 5b, is particularly beneficial in achieving a strong mechanical interlock with the polymeric material of the frame.

It is also within the scope of the invention to utilize a SEBS/TPU TPE material as the liquid polymeric molding material. The inventors have discovered that such material adheres surprisingly well to the metal bright trim piece of the molded trim assembly, even after weathering and with or without pre-heating of the metal trim piece. Quantitative results of laboratory testing of adhesion of the SEBS/TPU TPE material, made by GLS Corporation, are presented in Table 1. Such increased adhesion of the polymeric material to the bright trim piece, as well as to the glass substrate, as demonstrated in co-pending U.S. patent application Ser. No. 12/214,033 which is incorporated herein by reference, increases the overall integrity of the molded trim assembly, and minimizes the need to use other methods to ensure that the bright trim piece does not become detached from the molded trim assembly. As with the other liquid polymeric molding materials described herein, to obstain the best bonding results with the glass and the bright trim piece, application of an adhesion-promoting primer to one or both of the sheet and the trim piece is preferred.

TABLE 1

| | PEELS | | | LAP SHEARS | | |
|---|---|---|---|---|---|---|
| | LOAD | ST. | | LOAD | ST. | |
| CONDITIONS | (LBF) | DEV. | FAILURE MODE | (LBF) | DEV. | FAILURE MODE |

SUMMARY CHART - GLS 123 (IR HEAT 200 F.)

| | | | | | | |
|---|---|---|---|---|---|---|
| AMBIENT | 35 | 5 | 86% CF 10% TT 4% RMP | 82 | 2 | 100% TT |
| 1000 HRS AT 80° C. | 36 | 2 | 100% CF | 84 | 3 | 100% TT |
| 20 CYCLES | 35 | 4 | 96% CF 4% RMP | 76 | 10 | 100% TT |
| WAX | 32 | 1 | 100% CF | 77 | 3 | 100% TT |
| WAX REMOVER | 34 | 5 | 90% CF 10% TT | 81 | 2 | 100% TT |
| KEROSENE | 32 | 4 | 90% CF 10% TT | 80 | 2 | 100% TT |
| COOLANT | 34 | 3 | 80% CF 20% TT | 79 | 2 | 100% TT |
| WINDOW WASHER | 31 | 3 | 90% CF 10% TT | 76 | 2 | 100% TT |
| GASOLINE | 32 | 3 | 100% CF | 78 | 10 | 100% TT |

SUMMARY CHART - GLS 123 (NO IR HEAT)

| | | | | | | |
|---|---|---|---|---|---|---|
| AMBIENT | 46 | 2 | 87.5% CF 12.5% TT | 74 | 7 | 100% TT |
| 1000 HRS AT 80° C. | 51 | 5 | 80% CF 20% TT | 85 | 7 | 100% TT |
| 20 CYCLES | 40 | 2 | 70% CF 30% TT | 80 | 4 | 100% TT |
| WAX | 41 | 5 | 100% CF | 76 | 3 | 100% TT |
| WAX REMOVER | 42 | 3 | 80% CF 20% TT | 78 | 2 | 100% TT |
| KEROSENE | 42 | 3 | 100% CF | 72 | 5 | 100% TT |
| COOLANT | 40 | 10 | 100% CF | 72 | 2 | 100% TT |
| WINDOW WASHER | 39 | 2 | 86% CF 14% PM | 62 | 5 | 100% TT |
| GASOLINE | 35 | 4 | 100% CF | 77 | 1 | 100% TT |

SUMMARY CHART - APCO SUMIFLEX GC20 AND GPI1650

| | | | | | | |
|---|---|---|---|---|---|---|
| AMBIENT | 8 | 1 | 100% CF | 53 | 10 | 80% TT 16% CF 4% PM |
| 1000 HRS AT 80° C. | 7 | 1 | 98% CF 2% PM | 55 | 5 | 54% CF 40% TT 6% PM |
| 20 CYCLES | 7 | 1 | 100% CF | 53 | 9 | 60% TT 32% TT 8% RMP |
| WAX | 9 | 1 | 100% CF | 47 | 11 | 40% TT 38% CF 22% PM |
| WAX REMOVER | 8 | 1 | 100% CF | 52 | 9 | 48% CF 40% TT 12% RMP |
| KEROSENE | 9 | 4 | 90% CF 10% RMP | 48 | 12 | 48% CF 40% TT 12% PM |
| COOLANT | 8 | 3 | 100% CF | 57 | 7 | 60% TT 38% CF 2% RMP |
| WINDOW WASHER | 10 | 1 | 100% CF | 54 | 9 | 80% TT 14% CF 6% RMP |
| GASOLINE | 9 | 1 | 100% CF | 51 | 9 | 60% TT 35% CF 5% PM |

SUMMARY CHART - APCO SUMIFLEX GPI1650

| | | | | | | |
|---|---|---|---|---|---|---|
| AMBIENT | 9 | 1 | 96% CF 4% PM | 43 | 20 | 40% TT 34% CF 26% PM |
| 1000 HRS AT 80° C. | 8 | 1 | 100% CF | 56 | 6 | 80% TT 18% CF 2% PM |
| 20 CYCLES | 7 | 1 | 98% CF 2% PM | 57 | 3 | 100% TT |
| WAX | 9 | 1 | 100% CF | 48 | 14 | 40% TT 40% CF 20% PM |
| WAX REMOVER | 7 | 2 | 100% CF | 51 | 14 | 44% CF 40% TT 16% PM |
| KEROSENE | 8 | 1 | 100% CF | 45 | 10 | 52% CF 28% PM 20% TT |
| COOLANT | 7 | 1 | 96% CF 4% RMP | 41 | 13 | 73% CF 27% PM |
| WINDOW WASHER | 10 | 2 | 100% CF | 52 | 10 | 48% CF 40% TT 12% PM |
| GASOLINE | 8 | 2 | 100% CF | 44 | 12 | 52% CF 28% PM 20% TT |

SUMMARY CHART - SANTOPRENE LORD 205 AND CHEMLOK 487

| | | | | | | |
|---|---|---|---|---|---|---|
| AMBIENT | 4 | 0 | 94% RMP 6% PM | 15 | 13 | 72% PM 8% RMP |
| 1000 HRS AT 80° C. | 6 | 1 | 98% RMP 2% CF | 39 | 8 | 75% TT 20% RMP 5% PM |
| 20 CYCLES | 7 | 2 | 98% RMP 2% PM | 37 | 7 | 40% TT 33% RMP 26% PM 1% CF |
| WAX | 4 | 0 | 99% RMP 1% PM | 24 | 5 | 53% RMP 47% PM |
| WAX REMOVER | 4 | 0 | 100% RMP | 24 | 11 | 64% PM 20% TT 16% RMP |
| KEROSENE | 4 | 0 | 100% RMP | 25 | 5 | 55% PM 45% RMP |
| COOLANT | 4 | 2 | 88% PM 12% PM | 20 | 13 | 65% PM 35% RMP |
| WINDOW WASHER | 3 | 1 | 69% RMP 31% PM | 16 | 5 | 61% PM 39% RMP |
| GASOLINE | 4 | 0 | 98% RMP 2% PM | 22 | 6 | 62% PM 38% RMP |

SUMMARY CHART - SANTOPRENE CHEMLOK 487

| | | | | | | |
|---|---|---|---|---|---|---|
| AMBIENT | 4 | 1 | 96% RMP 4% PM | 35 | 4 | 98% RMP 2% PM |
| 1000 HRS AT 80° C. | 3 | 1 | 92% PM 8% RMP | 43 | 0 | 100% TT |
| 20 CYCLES | 3 | 0 | 58% RMP 42% PM | 41 | 2 | 100% TT |
| WAX | 2 | 1 | 72% PM 28% RMP | 34 | 4 | 73% RMP 27% PM |
| WAX REMOVER | 3 | 0 | 72% PM 28% RMP | 35 | 4 | 73% RMP 20% TT 7% PM |
| KEROSENE | 3 | 0 | 54% RMP 46% PM | 35 | 4 | 50% RMP 30% PM 20% TT |
| COOLANT | 3 | 1 | 53% RMP 47% PM | 33 | 5 | 45% RMP 40% TT 15% PM |
| WINDOW WASHER | 4 | 2 | 52% RMP 48% PM | 40 | 1 | 60% TT 40% RMP |
| GASOLINE | 3 | 1 | 51% PM 49% RMP | 37 | 3 | 84% RMP 16% PM |

FAILURE MODE GUIDE
CF = COHESIVE FAILURE OF TPE
TT = “TAIL TEAR” TPE WAS TORN
RMP = MOLDING MATERIAL TO METAL PRIMER
PM = PRIMER TO METAL

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are with the scope of the invention as determined by the appended claims when interpreted in accordance with the breadth to which they are fairly, legally and equitably entitled.

What is claimed is:

1. A method of making a molded trim assembly comprising:
providing a molding apparatus having separable upper and lower mold portions, wherein at least the lower mold portion comprises a mold cavity having a predetermined shape;
providing a glass sheet having at least one major surface and terminating in a peripheral edge portion, to at least a portion of which peripheral edge portion an adhesion-promoting primer is applied, wherein the peripheral edge portion of the glass sheet substantially conforms to the shape of the mold cavity;
pre-heating a trim piece having a base member and a brushed or polished show surface to a temperature greater than 120° F.;
positioning the trim piece in a predetermined location in the mold cavity adjacent at least a portion of the peripheral edge portion of the glass sheet;
pre-heating the glass sheet to a temperature greater than 120° F.;
placing the glass sheet in the lower mold portion so that at least a part of its peripheral edge portion extends into the mold cavity, and at least a part of its peripheral edge portion is adjacent the trim piece;
bringing the upper and lower mold portions into intimate molding contact;
injecting a sufficient quantity of a liquid polymeric material into the mold cavity, and allowing the polymeric material to come into bonding contact with the desired portion of the peripheral edge portion of the glass sheet, as well as with the base member of the trim piece;
allowing a sufficient time for the polymeric material to cure so as to form an integral trim assembly comprising the glass sheet, the trim piece and a molded polymeric frame bonded thereto;
separating the upper and lower mold portions; and
removing the integral trim assembly from the lower mold portion.

2. The method defined in claim 1, wherein the glass sheet is a vehicle window.

3. The method defined in claim 1, wherein the adhesion-promoting primer comprises a silane-based primer.

4. The method defined in claim 1, wherein the glass sheet is pre-heated in a location remote from the molding apparatus.

5. The method defined in claim 1, wherein the glass sheet is pre-heated in the molding apparatus.

6. The method defined in claim 1, wherein the bright trim piece is pre-heated in a location remote from the molding apparatus.

7. The method defined in claim 1, wherein the bright trim piece is pre-heated in the molding apparatus.

8. The method defined in claim 1, wherein the liquid polymeric material comprises a polyol compound and an isocyanate compound which chemically react within the molding apparatus.

9. The method defined in claim 1, wherein the liquid polymeric material comprises polyvinyl chloride.

10. The method defined in claim 1, wherein the glass is pre-heated to a temperature greater than or equal to 180° F.

11. The method defined in claim 1, wherein the bright trim piece is pre-heated to a temperature greater than or equal to 180° F.

12. The method defined in claim 1, wherein the glass is pre-heated to a temperature greater than or equal to 200° F.

13. The method defined in claim 1, wherein the bright trim piece is pre-heated to a temperature greater than or equal to 200° F.

14. A method of making a molded trim assembly comprising:
providing a molding apparatus having separable upper and lower mold portions, wherein at least the lower mold portion comprises a mold cavity having a predetermined shape;
providing a glass sheet having at least one major surface and terminating in a peripheral edge portion to at least a portion of which peripheral edge portion an adhesion-promoting primer is applied, wherein the peripheral edge portion of the glass sheet substantially conforms to the shape of the mold cavity;
pre-heating a trim piece having a base member and a brushed or polished show surface to a temperature greater than or equal to 200° F. in a location remote from the molding apparatus;
positioning the trim piece in a predetermined location in the mold cavity adjacent at least a portion of the peripheral edge portion of the glass sheet;
pre-heating the glass sheet to a temperature greater than or equal to 200° F. in a location remote from the molding apparatus;
placing the heated glass sheet in the lower mold portion so that at least a part of its peripheral edge portion extends into the mold cavity, and at least a part of its peripheral edge portion is adjacent the trim piece;
bringing the upper and lower mold portions into intimate molding contact;
injecting a sufficient quantity of a liquid polymeric material into the mold cavity, and allowing the polymeric material to come into bonding contact with the desired portion of the peripheral edge portion of the glass sheet, as well as with the base member of trim piece;
allowing a sufficient time for the polymeric material to cure so as to form an integral trim assembly comprising: the glass sheet, the trim piece with exposed visible brushed or polished show surface and a molded polymeric frame bonded thereto;
separating the upper and lower mold portions; and
removing the integral trim assembly from the lower mold portion.

15. The method defined in claim 1, wherein the liquid polymeric material is a SEBS/TPU TPE material.

16. The method defined in claim 14, wherein the adhesion of the polymeric material to the bright trim piece is ≧30 lb. ft. peel strength and ≧70 lb. ft. lap shear strength.

17. The method defined in claim 1, wherein the trim piece and/or the glass sheet are pre-heated by induction heating.

18. The method defined in claim 12, wherein the trim piece and/or the glass sheet are pre-heated by induction heating.

19. The method defined in claim 15, wherein neither the trim piece nor the glass sheet are pre-heated.
